(19) United States
(12) Patent Application Publication
(10) Pub. No.: US 2010/0059601 A1
(43) Pub. Date: Mar. 11, 2010

(54) Energy conserving vapor-dispersing device with optional repeating off cycles

(75) Inventors: Jeffrey Bankers, Phoenix, AZ (US); Sanam Nassirpour, Phoenix, AZ (US); Kevin Hafer, Chandler, AZ (US)

Correspondence Address: THE DIAL CORPORATION, 19001 N. Scottsdale Road, SCOTTSDALE, AZ, 85255, US

(73) Assignee: The Dial Corporation

(21) Appl. No.: 12/231,723

(22) Filed: Sep. 5, 2008

(51) Int. Cl. B05B 17/00

(52) U.S. Cl. 239/44

(57) ABSTRACT

An electrical vapor-dispersing device is described that vaporizes volatizable material continuously and uninterrupted when first plugged into an AC electrical source, but upon operation of an initiator switch begins cycling fixed “OFF/ON” periods preset at from about 6 to about 18-hours to conserve both energy and volatizable material. In the preferred embodiment, an LED signals when the total elapsed “on-time” reaches a set value and refill of the volatizable material is required. The device is returned to constant operation only by unplugging from the electrical source and plugging back in to the electrical mains, or by electrical power failure/interruption.

### FIELD OF INVENTION

The present invention relates to electrical vapor-dispersing devices and in particular to a plug-in vapor-dispersing device with repeating energy-conserving cycles optionally and irreversibly started by the user. More specifically, the present invention is a diffuser that vaporizes volatizable material continuously and uninterrupted when first plugged into an electrical outlet, but upon operation of an initiator switch begins irreversible repetition of fixed “ON”/“OFF” cycles to conserve both energy and volatizable material.

### BACKGROUND

Vapor-dispersing devices are well known and include a variety of devices for vaporizing a liquid such as a perfume, odor neutralizer, air sanitizer or insecticide into the surrounding environment. For example, vapor-dispersing devices include; electrical diffusers with resistive heating elements and/or fans for driving liquids into the vapor phase; and, passive devices that rely on large pads or fiber wicks for evaporating liquids without energy input.

Vapor-dispersing devices that are electrically powered are very common in home and institutional settings around the world and include air fresheners, insecticidal devices, humidifiers, medicament inhalers and aroma therapeutic vaporizers. These devices may comprise a reservoir of volatizable material and they may operate by heat to volatize the composition. Most common of these devices are “plug-in” air fresheners wherein a wick constructed of porous material is placed in communication with a reservoir of scented fragrance oil. The wick, operating as both a liquid capillary transfer means and evaporative member, is placed in close proximity to a resistive heating element that accelerates the evaporation of the liquid from the wick. Another common configuration for a household air freshener comprises a bottle of scented fragrance oil with a porous plastic wick positioned in front of a fan. In these devices the fan moves air across the wick and the scented air is expelled into the immediate environment. Yet another configuration is where the device incorporates both a heating element and a fan. These devices exist in the marketplace, both house current powered (110 v/220 v, AC) and battery powered (1.5 v, 3 v, 9 v, etc., DC). Exemplary plug-in electric diffusers include Glade® Plugins® Scented Oil air freshener from S.C. Johnson & Son and Airwick® Scented Oils air freshener from Reckitt Benckiser. An obvious limitation of these (and many other) plug-in electrical diffusers is that they run continuously and uninterrupted when plugged into an electrical outlet. For most electrical diffuser applications it is not necessary or even desirable to vaporize material continuously. For example, with air fresheners there is little reason to volatize fragrance throughout the home when the occupants are asleep, or at night in institutional settings when public spaces are vacant. With insecticide diffusers, it may be desirable to vaporize insecticidal substances only throughout the night for protection against insects while sleeping. Low cost electric vapor-dispersing devices operate continuously unless they are unplugged from the electrical outlet. It is a waste of energy and materials to leave diffusers running uninterrupted. Certainly the need to make low cost diffusers is the most likely reason for this design simplicity. The addition of on/off switches or timing features necessarily adds to the cost, and even more so if any level of programmability is included in the device (e.g., where the consumer may adjust the length of both on- and off-time periods independently). Whether or not a vapor-dispersing device is best designed to run continuously or periodically depends upon a number of factors including; nature/form of the volatizable material; the application; the setting (institutional, industrial or residential); cost-of-goods/retail price/profit margin for the device; and, level of end-users' education/skill/familiarity to properly and safely interact with the device as instructed.

Timed vapor-dispersing devices are certainly known from the prior art and exist in the marketplace, appearing most prominently as timed aerosol sprayers in both institutional and residential markets. Airwick® FreshMatic® marketed by Reckitt Benckiser and the AutoFresh®, Microburst®, and AutoFresh® Pulse® timed aerosols by Technical Concepts are exemplary of timed aerosol air freshener products used in residential and institutional settings. Country Vet®, manufactured by Waterbury, is exemplary of a battery operated, timed aerosol insecticide sprayer.

U.S. Pat. No. 3,993,444 to Brown claims a fan driven air freshener with a timing circuit comprised of two capacitors and two resistors that allow the user to select between delay times of 15 or 30-minutes between the time periods when electricity is delivered to the fan motor.

U.S. Pat. No. 4,795,883 to Glucksman et al. claims an aroma generating apparatus and driver circuit. The driver circuit operates between a low frequency when the heating element is off and a high frequency when the heating element is powered. In this way, the driver circuit monitors the real time operation of the device and can trigger a true end-of-use signal when the real elapsed time reaches a predetermined point, thus eliminating the need for memory circuits. The on- and off-time periods are determined and fixed by the resistors and capacitors chosen and are preferably around 30-minutes each (FIG. 5 in Glucksman '883). The purpose of the on/off cycling is to reduce fragrance habituation (Id. at Column 1, Lines 49-56) and the purpose of the driver circuit is to both cycle the heating element and count real elapsed time the unit is “on”.

U.S. Pat. No. 4,798,935 to Pezaris claims a driver circuit (also described in Glucksman '883) that provides a rectified drive signal to the heating element of an aroma generating apparatus to affect a periodic discharge of aromatic vapor into the room to avoid fragrance habituation. A rectified AC signal is necessarily a fast-pulsed on/off DC signal that would provide only on/off cycling that is indiscernible to the consumer.

U.S. Pat. No. 4,830,791 to Muderlak et al. claims a timed fan-driven air freshener. The device includes a timer that generates periodic on-times at predetermined intervals. The preferred time span between pulses is presumably about 15-minutes (Column 4, Lines 53-57 in Muderlak '791). The device may be switched to an energy-saving mode where the fan is only activated when room light is sensed.

U.S. Pat. No. 5,105,133 to Yang claims a multiple-mode perfuming device that operates at predetermined intervals and also has a light-sensing mode so that the device will not needlessly operate at night. When the consumer selects the “INTERMITTENT MODE”, the timing circuit provides an intermittent output signal to the fan motor. There is no mention in the '133 patent of the magnitude of the “desired frequency of perfuming”, (Id. Column 3, Lines 8-11).

U.S. Pat. No. 5,175,791 to Muderlak et al. claims an elaborate fragrance diffuser wherein a timing circuit is used to vary the duty cycle to the heating element through the life of the volatile material in order to provide a more uniform evaporation rate over time.

U.S. Pat. No. 5,567,361 to Harper claims a fragrance device wherein a timing circuit is used to periodically expel fragrance that is allowed to accumulate within an enclosed space from a wick air freshener.

Lastly U.S. Pat. No. 6,854,717 to Millan claims an electrical diffuser with a timing circuit made inaccessible to the consumer. Although this device alternates between fixed “ON” and “OFF” cycles, the purpose of the unchangeable cycling is to reduce fragrance habituation. Although the preferred periodicity is not described, a purpose of that invention is to deliver “ON”/“OFF” periods “not perceivable” by the user (Id. Column 2, Lines 4-5, and claim 1) rather than periods of several hours or more.

### SUMMARY OF THE INVENTION

What is lacking both in the prior art and in the market is a low cost electrical vapor-dispersing device that offers selection from continuous to energy-conserving modes, and in particular between a “default” continuous mode of operation and an energy-conserving intermittent mode of operation that may be irreversibly elected to override the default mode of operation. Thus it is broadly an object of the present invention to provide a vapor-dispersing device adapted for a default continuous operation and optional pre-set energy-saving operation. That being said, the present invention relates to an energy conserving vapor-dispersing device that minimally comprises a timer circuit of fixed periodicity that may be started by the consumer. The device of the present invention will operate continuously and uninterrupted unless the consumer elects to switch it to the energy-conserving mode by depressing a momentary contact switch, in which case the device will enter into repeating and fixed “ON/OFF” cycles that cannot be altered. The device may be returned to the continuous operation mode only by purposeful or unintentional power interruption, not by activating a switch. That is, the default continuous operation of the device is restored only if the device is unplugged and plugged back into an electrical outlet, or if there is an otherwise unintentional power failure.

The device of the present invention may also include an indicia means, such as a single color or multiple-color LED or lamp(s) that may signal to the user that the device is operating (i.e., “ON”) rather than sleeping (i.e., “OFF”), and/or that the “end-of-life” of the volatizable material is reached and that the device should be refilled with new material. Thus an additional goal of the present invention is to provide a relatively inexpensive vapor-dispersing device that can signal to the user important events such as when the device is “ON” versus “OFF”, or when in need of volatizable material replacement, preferably through a single LED.

The cost of the device of the present invention is kept exceptionally low by incorporating only minimal electronics; a simple timing circuit having fixed time cycles that cannot be changed by the consumer; a single momentary contact switch to optionally and irreversibly enter the energy-savings mode; and, an optional LED or other suitable indicia means. In the preferred embodiment, the vapor-dispersing device of the present invention is refillable by trading out an empty reservoir with a new reservoir of volatizable material. In this way a low cost, reusable and sustainable vapor-dispersing device is provided that features an optional energy-saving mode that saves both electricity and volatizable material.

### BRIEF DESCRIPTION OF THE DRAWING FIGURES

FIG. 1 depicts an embodiment of the vapor-dispersing device of the present invention that includes a vapor delivery means and circuit means within an overall housing structure, an indicia means and an initiator switch, viewable and accessible, respectively, to the user.

FIG. 2 depicts a top perspective view of one embodiment of the vapor-dispersing device of the present invention, showing an initiator switch useable to irreversibly enter into the energy-saving mode and an LED that may signal various events of importance to the user.

FIG. 3 depicts a side view of one embodiment of the vapor-dispersing device of the present invention showing an embodiment of an initiator button usable to irreversibly enter the device into the energy-saving mode of operation.

FIG. 4 depicts a front view of one embodiment of the vapor-dispersing device of the present invention showing an optional window for viewing the volatizable material reservoir.

FIG. 5 depicts a perspective view of a cross-section through one embodiment of the vapor-dispersing device of the present invention, showing examples of placement of various components therein.

FIG. 6 depicts a diagram of one embodiment of the circuit means for use in the present invention further comprising a timing/control circuit, rectified power source, indicia means, resistive heating element, and momentary SPST switch usable to trigger the device into the energy-saving mode of operation.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function, the size, and arrangement of the elements described without departing from the scope of the invention as set forth in the appended claims. Most importantly, changes in overall shape and size of the vapor-dispersing device do not depart from the intended scope of the invention. Additionally, the placement, shape, form and type of initiator switch used to enter the device of the present invention into the energy-conserving mode of operation may each be varied considerably, and all variations are considered within the spirit of the invention. For example, the switch may be a small round button, toggle or other lever, or other spring-loaded contact switch of any size or shape, or the like, and which may be positioned anywhere around the device. Similarly, the optional indicia means used to signal important events to the user may be any LED or any other visible indicator lamp of any size of color(s), and may be positioned anywhere around the device. Also, various shapes and sizes for the reservoir used to hold the volatizable material of the present invention are variable in shape, size and materials of construction, and all are anticipated to be within the scope of the invention, Lastly, electronics that achieve the same overall timing/energy-conserving purpose, even through comprised of alternative components varying widely from those described herein, are anticipated. For example, different timing circuits (e.g., flip-flop, monostable, or other) may be conceived and may be interchangeable with the preferred circuit means of the present invention described herein, yet still achieve the desired fixed “ON”/“OFF” energy-conserving periodicity required for the device.

That said, the present invention is a low cost electrical vapor-dispersing device that operates in a “default” continuous mode unless an energy-conserving intermittent mode of operation is started that will necessarily override the default mode of operation. The present invention is limited to a vapor-dispersing device that vaporizes volatizable material by means of heat radiating from at least one electrically energized resistive heating element, and wherein the device minimally comprises: a housing with walls enclosing an interior space; an electrically powered vapor delivery means within the housing for volatilizing a vaporizable material; a vent anywhere on the housing; a circuit means substantially within the housing, electrically coupled to the vapor delivery means, where the circuit means includes a timing circuit preset to cut off electrical power to the vapor delivery means in fixed repeating cycles when activated; and, an initiator or “start” switch, electrically coupled to the timing circuit for irreversibly activating the cyclical energy-conserving mode of operation. Additionally the device of the present invention may include an optional indicia means such as an LED to alert the user of events occurring in the device and/or the status of the device. These elements are more easily understood by discussions of each of the accompanying drawing figures and illustrations of preferred embodiments therein.

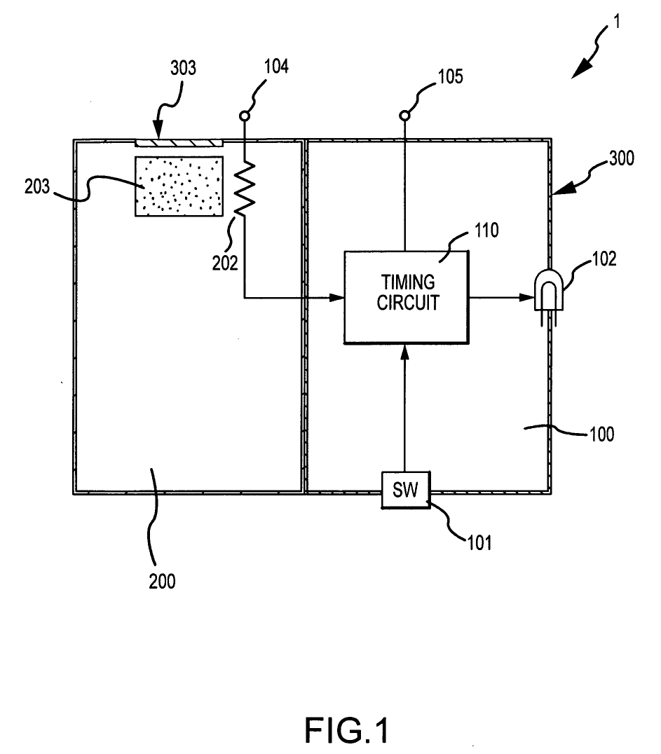

Referring now to FIG. 1, the vapor-dispersing device 1 of the present invention comprises a combination of a circuit means 100 and vapor-delivery means 200, both substantially encased within an overall housing 300 that has at least one vent 303 leading to the outside. An initiator switch 101, optional indicia means 102, and electrical contacts 104 and 105 used to electrically connect the device directly or through respective prongs with an AC electric source or “outlet”, are also shown. Circuit means 100 preferably includes a timer circuit 110, and vapor-delivery means 200 preferably includes an electrically powered resistive heating element 202. The vapor-dispersing device as shown in FIG. 1 operates to continuously vaporize a volatizable material 203 by means of the heat emanating from the electrically powered resistive heating element 202 unless the initiator switch 101 is operated to irreversibly place the device into an energy-conserving mode comprising repeating “ON”/“OFF” cycles. Optional indicia means 102 may be eliminated entirely for a very low-cost embodiment of the device, or it may be deployed to signal one or more events to the user, such as when the device is operating (in an “ON” cycle rather than “OFF” cycle), and/or when the volatizable material is expired, and so forth.

It is important not to read spatial relationships or geometrical constraints into FIG. 1. For example, electrical contacts 104 and 105 may not protrude as such from the housing 300, but rather may be entirely recessed within 300, consisting only of solder points on an etched circuit board which then lead to electrical prongs to which electricity is applied. Additionally, the initiator switch 101 and the optional indicia means 102 may physically protrude to various proportions from the housing 300 or may be substantially recessed within. For example, indicia means 102 may be recessed yet visible through a small hole in the housing 300 or visible through a clear window on the housing, or it may be configured to be bright enough when lit to be visible even through a thin walled portion of the housing 300. The timing circuit 110 may be left entirely inaccessible to the user and buried inside the housing 300, whereas certain elements of the vapor-delivery means 200, (most particularly a reservoir containing volatizable material 203) may protrude from the housing structure 300 so that the user may grip it and pull it out, (described below). On the other hand, switch 101 may be located such that it partially protrudes from the housing (e.g., through a small hole), e.g. wherein the base of the switch and its soldered electrical contacts/circuit board mounts remain within the housing 300. Lastly, the resistive heating element 202 may be physically distanced from the timing circuit 110 and connected to it by wires rather than soldered directly to a circuit board that embodies the timing circuit.

The housing 300 defines the overall shape of the device 1, with walls defining an interior. The housing may be comprised of any suitable material such as metal, plastic, glass or fiberboard, or combinations thereof, with blow-molded or injection-molded plastic being most preferred and practical materials of construction. It is important to note that the overall housing may be comprised of housing portions that are separately molded and later assembled to define the overall shape to the device, and which can provide for structural complexity inside and outside of the overall shell of the device. For example, housing portions may be screwed together, or fit together with plastic protrusions and holes, or sonically welded together to form the overall housing 300. The shape of the housing may be cylindrical, or more box or block-like in shape, or may be some other practical and appealing overall shape, and may include various interior shelves, recesses and mounting surfaces for various interior components, along with contours, colors and exterior ornamentation for aesthetic reasons. Overall, the housing 300 is essentially a container with walls that define an interior space in which various components of the present device (printed circuit board, etc.) may be placed and held. As mentioned, the configuration of the housing, and the placement of the components therein, may lead to various degrees of user accessibility for each of the particular components. The most preferred materials of construction for the housing 300 of the present invention are polyethylene, polypropylene, polybutylene, polystyrene, polycarbonate, polyvinyl chloride, and polyethylene terephthalate, or mixtures thereof, wherein the preferred plastic materials are blow-molded, injection blow-molded, injection molded, and/or thermoformed to create the various shapes of the housing portions. The housing 300 may be created to appear opaque or transparent (in part or in whole) and may be constructed of any color (e.g., white or beige or some decorative color). Construction from injection molded plastic allows for transparent/clear, transparent/colored, or opaque/colored plastic parts, further allowing wide variation of functionality and aesthetic appeal.

The switch 101, depicted generically in FIG. 1, is referred to here as the “start”, “initiator”, or “starter” switch (terms used interchangeably). Its function is to irreversibly change the operation of the device from a default continuous and uninterrupted mode to the energy-conserving periodic mode of operation and is therefore electrically coupled to a timing circuit 110 (part of the circuit means 100 explained below). One paramount difference between the vapor-dispersing device of the present invention and prior vapor diffusers is that the ability to switch the device into a periodic mode of operation is irreversible in the device of the present invention. As mentioned above, the purpose of the present invention is to provide a low-cost vapor-dispersing device that functions continuously when first plugged into an electrical source, but that may be switched into a periodic energy-conserving mode of operation if desired by the user. Once switched into the periodic mode, the only way to return the present device to a continuous operating mode is to interrupt power to the device (either by purposely unplugging it, or through unintentional power failure). To comport with this simplicity and to follow the low cost-of-goods strategy behind the design of the device as such, switch 101 is preferably a momentary contact type switch. That is, incorporation of multiple position switches that allow selection between various modes of operation for a more complicated, multi-functional device is beyond the scope of the present invention.

Momentary contact switches are highly common, and may be miniature or sub-miniature in size for inclusion in the device of the present invention. The switch 101 may preferably be a momentary contact rocker, toggle, pushbutton or slide switch. Most preferred is to use a switch 101 comprising a miniature or subminiature momentary contact pushbutton switch. Exemplary of the most preferred switch 101 for use in the present invention are the 3M-series and 3S-Series PC mount miniature and subminiature pushbutton switches available from Carling Technologies. Whether or not a SPST, SPDT, DPST or DPDT switch with “momentary on” or “momentary off” operation is ultimately preferred, will be determined by the design of the timing circuit. As mentioned above, portions of the switch 101 may protrude from the housing 300 of the device, and in the most preferred embodiment wherein the switch 101 is a momentary contact pushbutton PC mount switch, the “button” potion of the switch may be allowed to protrude out from a small hole in the housing 300 so that it can be fully depressed. As will be discussed below in the context of the timing circuit, the preferred switch for inclusion in the present invention is a SPST momentary contact pushbutton switch, which is “momentarily on” when depressed.

The optional indicia means 102 may be any type of light source that operates to visibly signal to the user events occurring in the device, or the current status of the device.

For example, indicia means 102 may be a small indicator bulb of an incandescent type, or a spark-gap neon tube lamp, or may preferably comprise one or more LED's (light emitting diodes). Non-limiting examples of preferred LED's include bicolor LED's, or dual 2-color LED assemblies, SMD LED's, micro LED's, 3-10 mm LED's, rectangular LED's, single color LED's, infrared LED's, right-angle LED's, blinking LED's, and the like. The preferred LED may be chosen on the basis of: the particular events or status that requires signaling to the user, (for example, “ON”, and/or “end-of-life” of the volatizable material); the electronics, (including printed circuit board (PCB) design, cost, compatibility of the LED with other electronic components, current/voltage requirements etc); and, the physical layout of the PCB, its size constraints, location and orientation within the housing 300 of the device, (for example, orientation of the PCB may dictate the choice between a right-angle LED and a standard LED). Most preferred is to incorporate a suitable LED (such as a bicolor LED or an assembly of LED's) as the indicia means that may provide one color when the device is vaporizing volatile material (e.g., green, to signal that the device is running rather than off) and a second color to signal when the device is depleted of volatizable material (e.g., a red color, or a blinking color). Most preferred is to use a 3-pin bicolor LED such as the WP59EGW bicolor green/red LED available from Kingbright USA.

Referring still to FIG. 1, the device of the present invention includes a resistive heating element 202 within the vapor-delivery means 200. Resistive heaters are well known in the art and may comprise a single resistor, a plurality of resistors run in series or parallel, thin film heating “traces”, induction coils, or any other means for electrically generating heat from electrical current. Such heating elements are amply discussed in both U.S. Pat. No. 6,792,199 to Levine, et al, and European Patent Application EP716807 to Zobele, both incorporated herein in their entireties. Preferred heaters also include “thin-film” resistive heaters, although most preferred for use in the present invention is a standard resistive heater, either a single resistor, e.g. ceramic or standard resistor encased in a hollow ceramic block, or a plurality of resistors connected in series as described in U.S. Pat. No. 7,352,960 to Hafer et al., also incorporated herein in its entirety.

Lastly, and still referring to FIG. 1, the vapor-dispersing device of the present invention includes electrical connections 104 (load side) and 105 (neutral side). Most simply and most preferred, connections 104 and 105 may terminate as standard electrical prongs or pins protruding from a portion of the housing 300 such that they may be plugged into a standard electrical outlet as found in a home, office or institution, or these may be nodes and connection/solder points on a PCB that may be connected to such prongs. The electrical connections 104 and 105 may be connected by wires to metal prongs positioned on a rotating portion of the housing 300 in order to accommodate electrical outlets installed sideways or upside-down, (so-called “rotating plug-deck”). As mentioned earlier, electrical connections 104 and 105 do not necessarily need to end in “male configured” electrical prongs protruding from the housing 300. For example, connections 104 and 105 may be entirely recessed within the housing 300 if the device is designed for use with a separate electrical cord rather than plugged directly into an electrical outlet. The electrical source applied to the connections 104 and 105 may be from about 100 v to about 280 v AC depending on what country the device is to be configured for. For example, in the U.S., electrical connections 104 and 105 preferably end in the familiar flat prongs found on an infinite number of U.S. household appliances and electrical cords, set parallel to one another and protruding from the housing 300 at suitable length so they may be plugged into a standard U.S. household electrical socket. If necessary, electrical connections 104 may include a third “grounding” prong or pin common to U.S. electrical wiring. If the device is targeted to countries other than the U.S., connections 104 and 105 may lead to and end in suitably appointed pins or other conductors of electricity that conform to the local electrical outlets found in those countries. In that instance, the voltage source may be 220 v AC rather than 110 v. A survey of electrical prong configurations may be found in U.S. Pat. No. 7,313,321 to He et al, incorporated herein in its entirety. Most useful is the chart shown in FIG. 8 of the '321 patent. Non-limiting embodiments acceptable for the configuration of the electrical connections emanating from nodes 104 and 105 of the present device include all of the examples shown in FIG. 8 of the '321 patent. Thus, the electrically operated vapor-delivery means 200 included in the vapor-dispersing device of the present invention minimally comprises a resistive heating element 202 and a supply of volatizable material that may be placed into close proximity to the heat generated from the energized resistive heating element in order to achieve volatization.

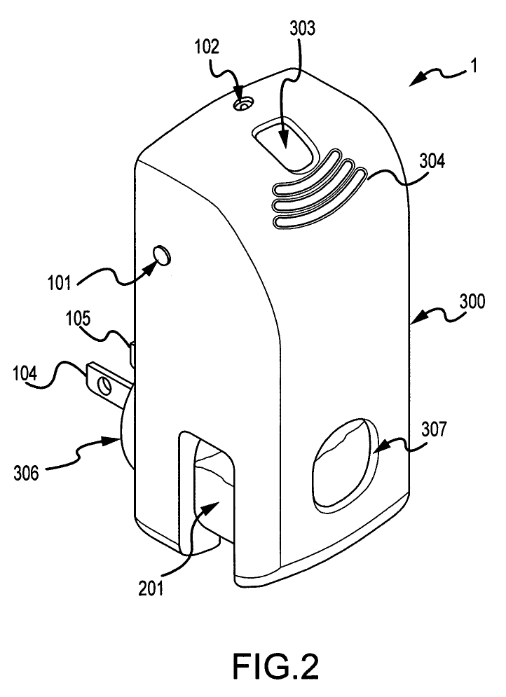

Referring now to FIG. 2, a preferred embodiment for the vapor-dispersing device of the present invention is depicted. As shown here, housing 300 may be shaped in a substantially rectangular shape with added contours for design aesthetics. Housing 300 further includes at least one vent 303 to allow movement of volatized vapor emanating from the wick below into the environment outside the device. As shown with the three curved slots 304 added at the top of the housing, additional vents may be used to enhance vaporization or to simply add aesthetic design. It must be stressed that the size, shape, and number of vents 303 is entirely variable. There may be one vent or there may be many in the housing. Additionally, the vent(s) may be covered with a mesh screen of sorts, or may be present in such number and small size that as a collection they appear as a mesh. The size/shape/number of the vent(s) may be adjusted for a number of reasons including; optimizing the evaporation rate of volatizable material; reducing internal condensation of emanating vapor, ease of molding the housing 300; aesthetics; and of course, safety. Also visible in FIG. 2 are; the indicia means 102, (which in this preferred embodiment is a recessed LED indicator); the initiator switch 101, (which in this preferred embodiment is a momentary contact pushbutton switch); the electrical connections 104 and 105 as preferably configured as flat parallel prongs suitable for 110 v U.S. households and institutions; a rotating plug deck 306 to allow the device to be reoriented to vertical (i.e., up righted) when the device is plugged into a sideways or upside down electrical outlet; and, lastly the reservoir 201 (used to contain the volatizable material 203, described in detail below). Seen in this preferred embodiment for the vapor-dispersing device is an added front window 307 to allow a better view of the volatizable material remaining within reservoir 201. As mentioned above, the housing 300 may be configured with open portions to allow access to the reservoir 201. In the preferred embodiment the housing 300 is constructed such that an opening is created toward the bottom portion to give the user access to the reservoir 201 for easy replacement.

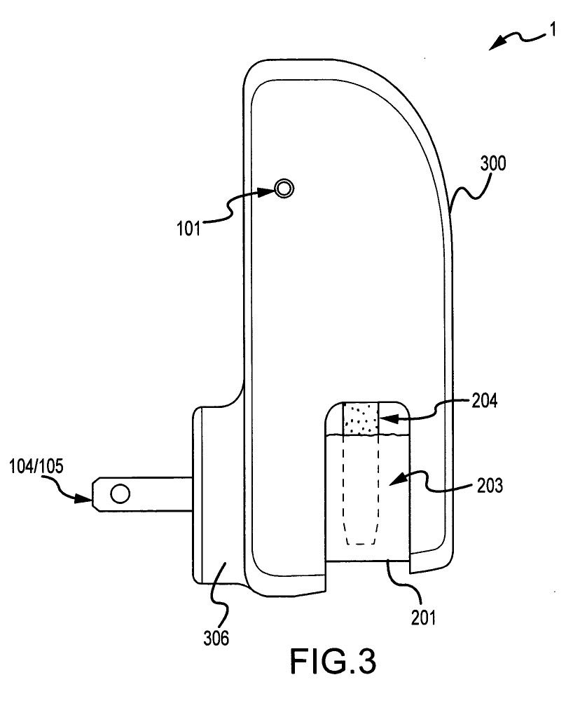

FIG. 3 illustrates a side view of a preferred embodiment of the vapor-dispersing device of the present invention. Elements described above are again visible in this view, namely; the initiator switch 101; one of the electrical connections 104 or 105 (configured here for 110 v U.S. electrical outlets); a rotating housing portion 306 of housing 300 (a “rotating plug deck”); and, reservoir 201. Reservoir 201 contains a volatizable material 203 and a porous wick 204 positioned through an opening in the reservoir such that it is in fluid communication with the volatizable material. Reservoirs and wicks such as 201 and 204 are well known in the art and are seen most commonly in the market as “scented oil refill” bottles for various plug-in electrical air fresheners. For air freshener applications, these reservoirs are normally small blow-molded plastic or molded glass bottles having a fill volume of from about 5 mL to about 45 mL, with around 25 mL to 30 mL being most preferred, and wherein the wick 204 is preferably a rod shaped piece of porous plastic. This preferred volume assumes a desired length-of-life of volatizable material to be about 30-45 days with an evaporation rate of volatizable material from the device to be about 15-30 milligrams per hour. However, for devices with periodic “ON”/“OFF” cycling, as per the present device, smaller volumes may be preferred since the volatizable material will last proportionately longer. Also, for applications such as insecticide or insect repellant delivery, the preferred volume of the reservoir may be quite different than that volume desired for air freshener applications. More specifically, the required volume for insecticides or insect repellants will depend on the concentration of active insecticide or repellant within the volatizable material.

For air freshener applications, the reservoir 201 to be used in the present invention preferably comprises a plastic or glass bottle having a fill volume of from about 5 mL to about 45 mL. If plastic is used for the reservoir, the preferred materials of manufacture include polypropylene, polyethylene, polyvinyl chloride, or polyethylene terephthalate, wherein the bottle is preferably blow-molded with a threaded neck to accept a screw cap. An opening is necessarily configured on one portion of the reservoir and that opening may be created from the blow-pin used in the plastic blow-molding operation, or it may be molded into a glass reservoir. A molded glass bottle is also preferred for its durability, beauty and clarity, and ease of recycling. Indeed, tying in with the energy-conserving emphasis of the present invention, a glass reservoir may appear more environmentally acceptable to the consumer. A glass bottle reservoir is also preferably molded with external threads on the neck portion of the opening in order to accept a screw cap. Preferably the reservoir is fitted with a porous plastic or other wick that extends to the bottom of the reservoir to ensure complete emptying. Suitable wick materials include cellulose fiber bundles, porous sintered plastic, wood, ceramics, graphite, and synthetic fiber bundles, and combinations of these materials, but as mentioned, the porous sintered plastic wicks are highly preferred. It is common in the art to also include a “fitment” or suitable molded plastic collar that snaps over the opening of the bottle to adapt the reservoir opening to a smaller hole that accepts and seals around the wick. The fitment also provides a better sealing platform for a screw cap. Such a screw cap can then be used to seal the bottle and wick together (a so-called “witch hat” shaped cap that covers the exposed end of the wick and seals down around the neck fitment and the screw threads of the bottle). Such configurations for the reservoir, fitment, porous wick and screw cap assembly are well described in U.S. Patent Application Publications 2006/0022064 to Triplett, et al. and 2005/0191481 to He, et al., along with PCT Application Publication WO/2002030220 to He, et al, all incorporated herein in their entireties. In order to effectuate volatization of the volatizable material from the vapor-delivery means of the present device, the wick is positioned in close proximity to the previously described resistive heating element 202. In this way, when the resistive element is energized, the emitted heat will warm the saturated porous wick, vaporizing the volatizable material. To achieve the alignment of the reservoir such that its wick is placed into close proximity to the heating element, a guidance system as that claimed in U.S. Pat. No. 6,104,867 to Stathakis, et al. may be readily employed within the design of the housing 300 of the present invention.

The volatizable material 203 in the reservoir 201 for evaporation from the device of the present invention may be present from about 1 gram to about 50 grams. Depending on whether the composition is a fragrance or an insecticide or other air treatment mixture, the composition may contain anywhere from trace actives to 100% actives and may contain any number and amount of solvents and/or carriers, volatile or otherwise. For example, the device of the present invention may comprise a volatile material further consisting of only a single volatile chemical such as citronella. In another embodiment of the invention the volatile material may comprise only eucalyptus oil as a medicament. The material may comprise anywhere from one or a few to up to many active materials dissolved or compounded with solvents and carriers that may or may not be volatile. Most preferred is to utilize volatile mixtures (comprising mixtures of actives and solvents together) wherein all of the components are volatile such that the reservoir 201 will eventually empty of all visible contents after a predetermined use-up period referred to as the “end-of-life”. Most preferred is to place from about 5 mL to about 45 mL of a liquid or gelled volatizable material 203 within reservoir 201.

For use as a fragrance-dispersing device, fragrance components of the volatizable material 203 for the present invention may comprise one of more volatile organic compounds available from any of the now known, or hereafter established, perfumery suppliers, such as International Flavors and Fragrances (IFF) of New Jersey, Givaudan of New Jersey, Firmenich of New Jersey, etc. Many types of fragrances can be used in the present invention. Preferably the fragrance materials are volatile essential oils. The fragrances, however, may be synthetically derived substances (aldehydes, ketones, esters, etc.), naturally derived oils, or mixtures thereof. Naturally derived fragrance substances include, but are not limited to, musk, civet, ambergis, castoreum and like animal perfumes; abies oil, ajowan oil, almond oil, ambrette seed absolute, angelic root oil, anise oil, basil oil, bay oil, benzoin resinoid, bergamot oil, birch oil, bois de rose oil, broom abs., cajeput oil, cananga oil, capsicum oil, caraway oil, cardamon oil, carrot seed oil, cassia oil, cedar leaf, cedarwood oil, celery seed oil, cinnamon bark oil, citronella oil, clary sage oil, clove oil, cognac oil, coriander oil, cubeb oil, cumin oil, camphor oil, dill oil, estragon oil, eucalyptus oil, fennel sweet oil, galbanum res., garlic oil, geranium oil, ginger oil, grapefruit oil, hop oil, hyacinth abs., jasmin abs., juniper berry oil, labdanum res., lavander oil, laurel leaf oil, lavender oil, lemon oil, lemongrass oil, lime oil, lovage oil, mace oil, mandarin oil, mimosa abs., myrrh abs., mustard oil, narcissus abs., neroli bigarade oil, nutmeg oil, oakmoss abs., olibanum res., onion oil, opoponax res., orange oil, orange flower oil, origanum, orris concrete, pepper oil, peppermint oil, peru balsam, petitgrain oil, pine needle oil, rose abs., rose oil, rosemary oil, sandalwood oil, sage oil, spearmint oil, styrax oil, thyme oil, tolu balsam, tonka beans abs., tuberose abs., turpentine oil, vanilla beans abs., vetiver oil, violet leaf abs., ylang ylang oil and like vegetable oils, etc. Synthetic fragrance materials include but are not limited to pinene, limonene and like hydrocarbons; 3,3,5-trimethylcyclohexanol, linalool, geraniol, nerol, citronellol, menthol, borneol, borneyl methoxy cyclohexanol, benzyl alcohol, anise alcohol, cinnamyl alcohol, β-phenyl ethyl alcohol, cis-3-hexenol, terpineol and like alcohols; anethole, musk xylol, isoeugenol, methyl eugenol and like phenols; α-amylcinnamic aldehyde, anisaldehyde, n-butyl aldehyde, cumin aldehyde, cyclamen aldehyde, decanal, isobutyl aldehyde, hexyl aldehyde, heptyl aldehyde, n-nonyl aldehyde, nonadienol, citral, citronellal, hydroxycitronellal, benzaldehyde, methyl nonyl acetaldehyde, cinnamic aldehyde, dodecanol, α-hyxylcinnamic aldehyde, undecenal, heliotropin, vanillin, ethyl vanillin and like aldehydes; methyl amyl ketone, methyl β-naphthyl ketone, methyl nonyl ketone, musk ketone, diacetyl, acetyl propionyl, acetyl butyryl, carvone, menthone, camphor, acetophenone, p-methyl acetophenone, ionone, methyl ionone and like ketones; amyl butyrolactone, diphenyl oxide, methyl phenyl glycidate, gamma.-nonyl lactone, coumarin, cineole, ethyl methyl phenyl glicydate and like lactones or oxides; methyl formate, isopropyl formate, linalyl formate, ethyl acetate, octyl acetate, methyl acetate, benzyl acetate, cinnamyl acetate, butyl propionate, isoamyl acetate, isopropyl isobutyrate, geranyl isovalerate, allyl capronate, butyl heptylate, octyl caprylate octyl, methyl heptynecarboxylate, methine octynecarboxylate, isoacyl caprylate, methyl laurate, ethyl myristate, methyl myristate, ethyl benzoate, benzyl benzoate, methylcarbinylphenyl acetate, isobutyl phenylacetate, methyl cinnamate, cinnamyl cinnamate, methyl salicylate, ethyl anisate, methyl anthranilate, ethyl pyruvate, ethyl α-butyl butylate, benzyl propionate, butyl acetate, butyl butyrate, p-tert-butylcyclohexyl acetate, cedryl acetate, citronellyl acetate, citronellyl formate, p-cresyl acetate, ethyl butyrate, ethyl caproate, ethyl cinnamate, ethyl phenylacetate, ethylene brassylate, geranyl acetate, geranyl formate, isoamyl salicylate, isoamyl isovalerate, isobornyl acetate, linalyl acetate, methyl anthranilate, methyl dihydrojasmonate, nopyl acetate, β-phenylethyl acetate, trichloromethylphenyl carbinyl acetate, terpinyl acetate, vetiveryl acetate and like esters, and the like. Suitable fragrance mixtures may produce a number of overall fragrance type perceptions including but not limited to, fruity, musk, floral, herbaceous (including mint), and woody, or perceptions that are in-between (fruity-floral for example). Typically these fragrance mixtures are compounded by mixing a variety of these active fragrance materials along with various solvents to adjust cost, evaporation rates, hedonics and intensity of perception. Well known in the fragrance industry is to dilute essential fragrance oil blends (natural and/or synthetic) with solvents such as ethanol, isopropanol, hydrocarbons, acetone, glycols, glycol ethers, water, and combinations thereof, and using solvent up to as much as 90% of the volatile fragrance composition. Thus a preferred fragrance composition for use as the volatizable composition 203 in the present invention is comprised of a mixture of many fragrance actives and volatile solvents, sometimes along with smaller amounts of emulsifiers, stabilizers, wetting agents and preservatives. More often than not, the compositions of the fragrance mixtures purchasable from the various fragrance supply houses remain proprietary.

Volatizable insecticide compositions for use in the present invention are those of the type described in U.S. Pat. No. 4,663,315 to Hasegawa, et al., incorporated herein by reference. Hasegawa describes many useful volatile insecticidal compositions that will work well within the reservoir 201 of the present invention.

Although the volatizable material 203 for use in the present invention has been described generally as a liquid, it is important to realize that this material may feature any range of viscosities. For example, the volatizable material placed into the reservoir for evaporation may be a “water-thin” liquid, a thickened gel, an emulsion or suspension, or a moderate to very viscous liquid, for example resembling a gel or a waxy semi-solid. Using volatizable material having substantially high viscosity has the advantage of added child resistance in that children are less likely to be able to suck thickened volatizable material through a porous wick at any appreciable dangerous rate. The volatizable material may be “naturally” thick depending on the ingredients used in its formulation, or it may be purposely thickened with silica gel, clay, synthetic or natural polymers or other structurant, as is well known in the art.

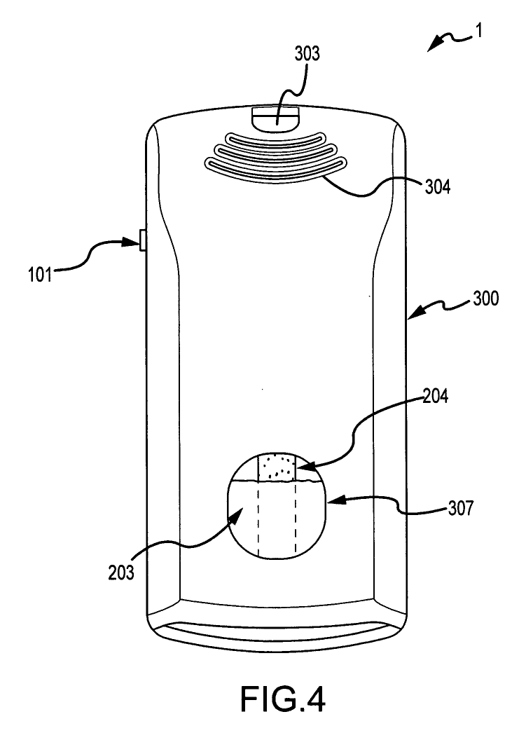

FIG. 4 illustrates a front view of a preferred embodiment of the vapor-dispersing device of the present invention. Visible in this view of device 1 are; the overall housing 300; preferred pushbutton initiator switch 101; at least one vent 303; additional optional decorative vents 304; window 307 molded into the housing 300; volatizable material 203; and, porous wick 204.

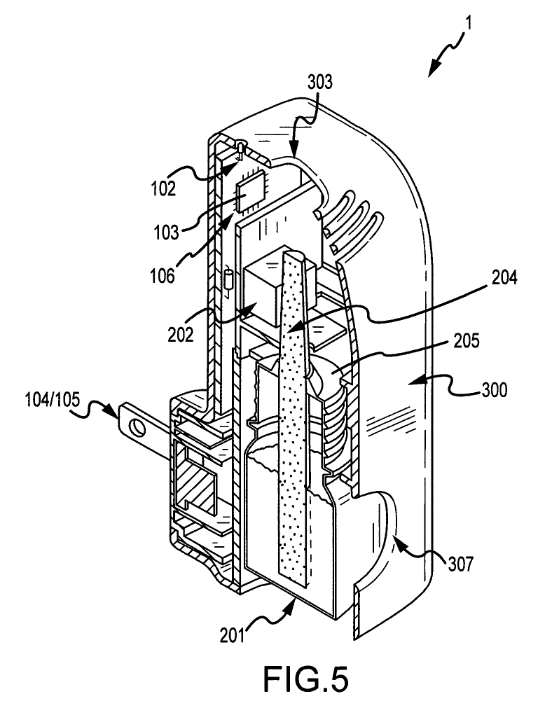

FIG. 5 illustrates a cross-section, (in perspective view), of an embodiment of the device 1 of the present invention to show preferred placement of various elements. Visible in this view is a printed circuit board (PCB) 106 that embodies the circuit means 100, for example including the timing microcontroller 103 and the indicia means 102 as shown. The resistive heating element 202 is preferably mounted on an internal structural member that it is physically remote from the PCB. Gleaned from FIG. 5 is one embodiment of an etched board 106 that may be used to accommodate the components of circuit means 100 into a compact size that will fit within the confines of housing 300. Obviously there are an infinite number of ways to design/etch a small PCB that will accommodate the circuit means 100.

Electrical connection from the PCB to the resistor 202 may be achieved with wires or simply by extending the pins of the resistor through the structural member and to solder points on the PCB. Additionally, wires may be used to bring the electrical power to the PCB, these being soldered between points on the PCB and the electrical prongs on the rotating plug deck. In this way the wires simply twist around freely if the rotating plug deck is utilized for sideways or upside down mounted electrical outlets. Reservoir 201 is shown to fit relatively snugly within the housing 300 when inserted from underneath the device and internal structural elements may be judicially located to help hold the reservoir therein. Reservoir 201 further comprises a collar/fitment 205 and porous wick 204 fitted within said collar 205 as described in detail above. As shown, the porous wick 204 is preferably positioned in close proximity to the resistive heating element 202 when the reservoir 201 is inserted into the housing 300. Vapors that emanate from the heated end of the wick 204 will necessarily migrate out of the vent(s) 303 and into the local environment such as a room of a house.

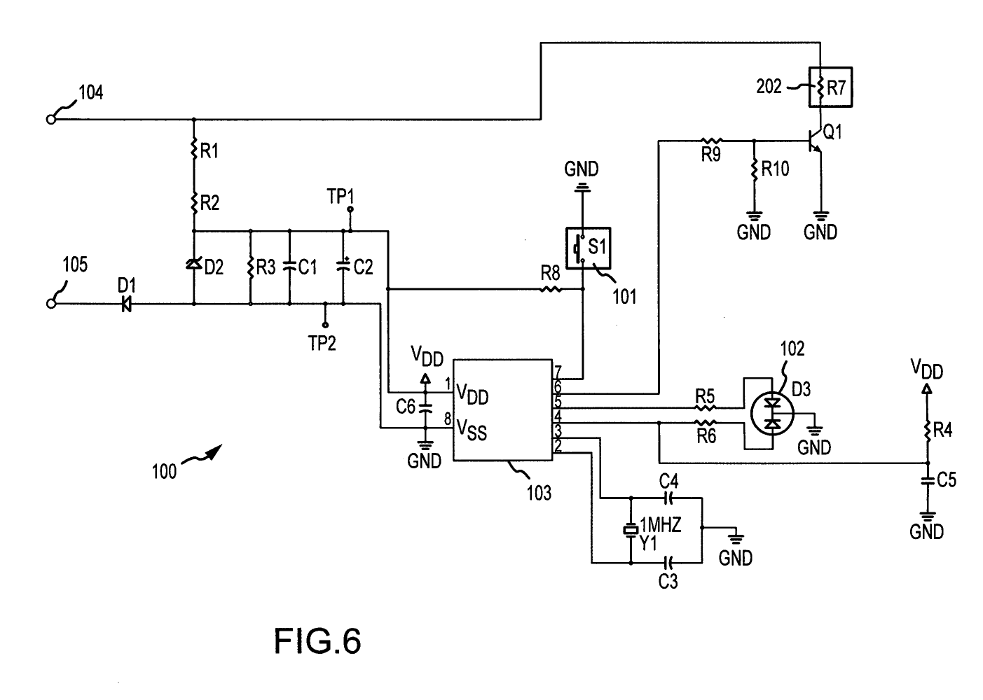

Referring now to FIG. 6, the vapor-dispersing device of the present invention includes a circuit means 100 further comprising a resistive heating element 202 (R7), initiator switch 101 (S1), indicia means 102 (bicolor green/red diode D3), and a timing/control circuit (essentially comprised of the 8-pin U1 timer 103, the external oscillator circuit comprised of crystal Y1 and capacitors C3 and C4 that may be used for a more accurate time base, along with R9, R10 and triac Q1 to control ON/OFF switching to resistive heating element 202). As shown, the timing circuit is preferably based around a “555-type” timer, or a microcontroller such as the PIC 12C508, 12F629, or any similar CMOS microcontrollers commercially available from many suppliers, for example such as from Microchip Technologies.

The OSC1 and OSC2 pins of the CMOS timer 103, (#2 and #3 pins, respectively), may be connected to an external oscillator further comprising a 1 MHz quartz crystal Y1 and capacitors C3 and C4, leading to ground, as is standard practice for more accurate timing. As is known, selection of capacitors C3 and C4 is important for stability, with larger capacitance giving better stability but longer oscillator startup times. To that end, both C3 and C4 should be less than 50 pF, and herein C3 is preferably from about 20 to about 25 pF, and C4 is from about 10 to about 20 pF.

Power to the resistive heating element 202 (R7) is half-wave rectified AC voltage. To that end, diode D1, Zener diode D2, resistors R1, R2, and R3, and filter capacitors C1 and C2, together form the half-wave rectifier circuit that feeds the heating element, and when filtered, supplies the DC voltage required by the microcontroller U1. As mentioned above, nodes 104 (load) and 105 (neutral) are connected through to an AC power source (e.g., through wires leading to metal prongs), which is this U.S. version is preferably from about 100 v to about 130 v AC. As configured in FIG. 6, voltage will be continuously supplied from node 104 (hot/load) through the resistive heating element 202 (R7) until the momentary initiator switch 101 (S1) is depressed, whereupon the timing circuit 110 controls the “ON”/“OFF” cycling to the heating element. As typical when large current surges are possible and spiking may occur during switching, a capacitor C6 is connected directly between the V_{DD} and V_{SS} pins of the CMOS timer 103 (U1) as shown.

The resistance of R4 and capacitance of CS provide time delay reset signal to the microcontroller. A small program in the microcontroller provides the timing sequences on the order of from about 21,600 sec (6 hrs) to about 64,800 sec (18 hrs). Most preferred is to adjust these dependent components to produce an “OFF” time duration of from about 6 hr to about 9 hr and an “ON” time duration of from about 12 hr to about 18 hr. In this way, the initiation of the timer circuit through momentary contact of switch S1 will place the device of the present invention into preferred “ON” times of about 8 hr and “OFF” times of about 16 hr. For this to be of practical use, the consumer will be instructed to press the initiator switch S1 upon retiring for the night (e.g., at 10:00 PM), which will then put the device into its first “OFF” cycle (of about 8 hrs for example), followed by successive “ON”/“OFF” cycling each 24 hr period. The preferred about 8 hrs “OFF” and about 16 hrs “ON” time durations come from the assumption a consumer would prefer the device to be “OFF” while sleeping for about 8 hr and “ON” while not sleeping for about 16 hr, with this periodicity repeating each day (24 hr cycle). As mentioned, for other applications other than an electric air freshener (e.g., insect repellant device), these cycle times may be much different and the capacitance and resistance of these components would be adjusted accordingly in order to achieve those desired cycle times.

As shown in FIG. 6, a triac Q1 is a preferred component of the timing circuit to effectuate the actual bidirectional switching. Many versions of sensitive gate triacs will suffice here, such as a MAC97A6, MAC97A8 (either from Philips) or a KSP42, KSP43, KSP44, KSP44M, or KSP45 NPN epitaxial silicon transistor from Fairchild. For the bidirectional switching, the base of the triac is necessarily connected to the microcontroller, the emitter is connected to the load (resistive heating element R7) and the collector to ground.

The circuit means of FIG. 6 also includes the above mentioned indicia means 102 (D3 in the circuit diagram). Preferred for use herein is the bicolor red/green LED, such as the WP59EGW bicolor indicator lamp from Kingbright amongst other suppliers, wherein the common cathode lead is connected to ground as depicted. Current limiting resistor R5 is connected to the red anode of D3 and current limiting resistor R6 is connected to the green anode lead. The values for these resistors are relatively small for the circuit as designed, on the order of less than 1 kΩ. The resistance of R5 and R6 may be varied to affect the intensity of the bidirectional LED. As configured in FIG. 6, the circuit means will direct current to the green anode lead of D3 only when current is supplied to the resistive heating element R7 and will shunt the current away from the green anode lead of D3 during the “OFF” cycles. Most importantly, the preferred circuit means in FIG. 6 is configured to take advantage of the FLASH data memory capability of the PIC 12F629 timer 103, wherein the total “ON” time is continually recorded (or “clocked”). In this way, red anode lead to D3 may be powered only at the expiration of a set “end-of-life” time period, such as 30-days or when the volatizable material is expected to be essentially gone. Configured as such, reaching the set “end-of-life” period does not terminate the “ON”/“OFF” cyclical heating of the resistive heating element R7. Instead the “ON”/“OFF” periodicity continues unbeknown to the consumer, since there is no longer a visual “ON” queuing. After the set “end-of-life” time period is reached, the green diode “ON” indicator is disabled and replaced with a constant red indicator light, even though the device continues to operate in the energy-saving “ON”/“OFF” mode. It is presumed then that upon seeing the red queue, the consumer will remove the device from the electrical outlet in order to replace the substantially empty reservoir, and in so doing will then plug the reloaded device back into the electrical outlet and once again press the initiator switch upon retiring for the night. That procedure will restore the “ON”/“OFF” periodicity wherein the green portion of D3 is lit during each “ON” period until, once again, the total “end-of-life” time period is clocked, at which the intermittent green queuing is replaced with a constant red indication.

The circuit means 100 as depicted in FIG. 6 functions to energize the resistive heating element 202 continuously until 101 (S1) is operated. It is important to note that conversion to the energy-saving mode of operation is irreversible even though voluntary. Voluntary operation of initiator switch 101 (S1) will irreversibly trigger the device into its energy-saving mode of “ON”/“OFF” cycling. There is no way to return the device to its continuous mode by operating switch 101 (S1) a second time. Only a power interruption to the device will restore the continual mode of operation. This feature is not taught by the prior art, and such a unique electronic design lends a very low cost way to inject some electrical programming/sophistication into a vapor-dispersing device that can be marketed as “energy-conserving”.

We have herein described a unique low-cost vapor-dispensing device 1 that features a consumer initiated energy-saving mode of operation. The device of the present invention will operate continuously and uninterrupted unless and until the consumer elects to switch it to the energy-conserving mode by operating a momentary contact switch, in which case the device will irreversibly enter into repeating and unchangeable “ON/OFF” cycles of from about 6 to about 18 hours. The device may be returned to the continuous operation mode only by purposeful or unintentional power interruption. As shown and described, the preferred embodiment for this unique device further includes a bicolor LED that signals “green” during each “ON” period, and “red” when the total elapsed “ON” time reaches a set value roughly corresponding to when the volatizable material is estimated to be emptied. Incorporation of only these few simple and inexpensive electronic features provide for a sustainable, environmentally friendly and consumer desirable, low-cost vapor-dispersing device.

We claim:

1. A vapor-dispersing device comprising:
a. a housing with walls enclosing an interior space;
b. a vent on said housing;
c. an electrically powered vapor delivery means substantially within said housing for vaporizing a volatizable material;
d. a circuit means substantially within said housing for controlling said vapor delivery means, said circuit means electrically coupled to said vapor delivery means, said circuit means comprising a timing circuit preprogrammed to control electrical power to said vapor delivery means in fixed repeating “ON”/“OFF” cycles when triggered; and,
e. a momentary contact switch, electrically coupled to said timing circuit for irreversibly starting said repeating “ON”/“OFF” cycles.

2. The vapor-dispersing device of claim 1, wherein said electrical power is from about 100 v AC to about 280 v AC.

3. The vapor-dispersing device of claim 2, wherein said vapor delivery means includes a resistive heating element.

4. The vapor-dispersing device of claim 3, wherein said vapor delivery means further comprises a reservoir containing said volatizable material, said reservoir having an opening fitted with a porous wick, said wick in communication with said volatizable material.

5. The vapor-dispersing device of claim 4, wherein said wick is comprised of material selected from the group consisting of cellulose fibers, porous plastic, wood, ceramics, graphite, and synthetic fibers, and mixtures thereof.

6. The vapor-dispersing device of claim 3, wherein said volatizable material is selected from the group consisting of synthetic fragrance substances, naturally occurring fragrance substances, odor neutralizing agents, water, organic solvents, insect repellants, insecticides, air sanitizing agents, aroma therapeutic agents, and medicaments, and mixtures thereof.

7. The vapor-dispersing device of claim 1, wherein said circuit means further includes an indicia means.

8. The vapor-dispersing device of claim 7, wherein said indicia means comprises an indicating light source selected from the group consisting of light emitting diodes, neon tubes and incandescent bulbs, and combinations thereof.

9. The vapor-dispersing device of claim 1, wherein said timing circuit further comprises a microcontroller and a bidirectional switching triac.

10. The vapor-dispersing device of claim 8, wherein said indicia means comprises a bicolor LED.

11. The vapor-dispersing device of claim 7, wherein said timing circuit includes a FLASH memory usable to record total time of accumulated said “ON” cycles, said circuit means lighting said indicia means at the end of a fixed time that roughly corresponds to the time when said reservoir is empty of said volatizable material.

12. A vapor-dispersing device comprising:
a. a housing with walls enclosing an interior space;
b. a vent on said housing;
c. an electrically powered vapor delivery means substantially within said housing for vaporizing a volatizable material, said vapor delivery means comprising a reservoir containing said volatizable material, said reservoir further comprising a porous wick in communication with said volatizable material;
d. a circuit means substantially within said housing for controlling said vapor delivery means, said circuit means electrically coupled to said vapor delivery means, said circuit means comprising a timing circuit preprogrammed to control electrical power to said vapor delivery means in fixed repeating “ON”/“OFF” cycles when triggered, said circuit means also including an LED indicator; and,
e. a momentary contact switch, electrically coupled to said timing circuit for irreversibly triggering said repeating “ON”/“OFF” cycles, wherein said LED indicator is lit for the duration of each said repeating “ON” cycle and is not lit for each said repeating “OFF” cycle.

13. A vapor-dispersing device comprising:
a. a housing with walls enclosing an interior space;
b. a vent on said housing;
c. an electrically powered vapor delivery means substantially within said housing for vaporizing a volatizable material, said vapor delivery means comprising a reservoir containing said volatizable material, said reservoir further comprising a porous wick in communication with said volatizable material;
d. a circuit means substantially within said housing for controlling said vapor delivery means, said circuit means electrically coupled to said vapor delivery means, said circuit means comprising a timing circuit preprogrammed to control electrical power to said vapor delivery means in fixed repeating “ON”/“OFF” cycles when triggered, said circuit means also including a bicolor LED indicator and a FLASH memory usable to clock said “ON” cycles; and,
e. a momentary contact switch, electrically coupled to said timing circuit for irreversibly triggering said repeating “ON”/“OFF” cycles, wherein said LED indicator is lit with one color only for the duration of each said repeating “ON” cycle, and with another color at the end of a fixed time period that roughly corresponds to the time when said reservoir is empty of said volatizable material.

14. The vapor-dispersing device of any of claims 1, 12 or 13, wherein said “ON” time within said “ON”/“OFF” cycle is fixed at from about 6 hours to about 18 hours and said “OFF” time within said “ON”/“OFF” cycle is fixed at from about 6 hours to about 18 hours, and wherein said fixed “ON” time and said fixed “OFF” time totals to an approximate 24 hr periodicity.
